(19) United States
(12) Patent Application Publication
(10) Pub. No.: US 2019/0369602 A1
(43) Pub. Date: Dec. 5, 2019

(54) COMMON CONTROL MODULE SYSTEM

(71) Applicant: TEREX USA, LLC, Westport, CT (US)

(72) Inventors: Payton SCHIRM, Vinton, IA (US); John SULLIVAN, Hiawatha, IA (US); Edwin J. SAUSER, Monticello, IA (US); Kevin McDERMOTT, Monticello, IA (US)

(73) Assignee: Terex USA, LLC, Westport, CT (US)

(21) Appl. No.: 16/477,965

(22) PCT Filed: Jan. 16, 2018
(86) PCT No.: PCT/US2018/013825

§ 371 Date: Jul. 15, 2019

Related U.S. Application Data
(60) Provisional application No. 62/447,210, filed on Jan. 17, 2017.

(51) Int. Cl. G05B 19/4155

(52) U.S. Cl. CPC G05B 19/4155; G05B 2219/32082

(57) ABSTRACT

A system for controlling one or more aggregate processing plants which utilizes a common control module disposed on each plant, where the module is produced to be functionally identical to, interchangeable with and replaceable by the same model of the model from the same manufacture. When several plants are configured to be controlled by the common control module, and the modules are interconnected by a canbus, then each module can be used to control the entire system of plants and individual other plants in the system without the need for any central control hub and spoke control lines extending directly to each of the plants. The system can be easily (with activation of just one button) set up to allow for common control of the various plants.

### CROSS REFERENCE TO RELATED APPLICATIONS

This application claims the benefit of provisional application filed on Jan. 17, 2017 and having Ser. No. 62/447,210; by the same inventors which is hereby incorporated herein in its entirety by this reference.

### BACKGROUND OF THE INVENTION

This invention relates to aggregate processing systems, rock crushing and screening plants and other road building material processing systems. More specifically, this invention relates to reconfigurable rock crushing, screening and aggregate processing plants which are capable of being towed or driven to accommodate changes in system location and/or configuration.

The aggregate industry utilizes a variety of platforms for crushing and screening machines which range from static structures, to semi-static relocatable machines, to portable wheeled trailer machines, to mobile track mounted machines. A variety of types and number of crushing and screening “machines or plants” are combined to manufacture the desired size and mixture of aggregate products. This combination of crushing and screening machines/plants is referred to as a crushing and screening “system”. Usually, all but the mobile tracked machines are dominated by electrical powered devices within the crushing or screening machines. These electrically powered devices can be controlled by independent control panels on each machine or by a centralized control station for all machines and devices within a system.

The independent control panels normally contain a push button station which may be mounted with the switchgear equipment or tethered to the switchgear equipment for remote control of device switchgear. A centralized control station can be as simple as placing all tethered control stations into a common location or it can be a complex control house with computer controls and sophisticated human machine interface “HMI”, that can have high levels of monitoring and automation.

The simple push button controls are typically manually operated switches for controlling the devices within each machine and for the system of machines. It is common that these types of controls have circuits designed so that the operation of a device is dependent on another device running before it is allowed to start. For example, a stacking conveyor must start and be running before the circuit to start the device discharging onto that stacking conveyor can be energized. This circuit also functions to shut down the upstream feeding device if the stacking conveyor switchgear fails.

Sophisticated centralized controls are frequently computer controlled. The computer, a programmable logic controller or “PLC”, is normally uniquely programmed to control a specific combination of devices in crushing and screening machines. A PLC or series of PLCs are designed to control and monitor devices within the crushing and screening system. Automation, start sequence, and interlocking are controlled by the programming of the PLCs. Systems with multiple PLCs typically have a master PLC and may have slave PLCs working together to operate devices in the system.

While such prior art aggregate processing systems have enjoyed considerable success in the past, they do have some drawbacks. The simple push button controlled systems typically require movement of a worker around the system, between several machines, to start and stop and troubleshoot the machines in the system. The centralized control aggregate processing system designs often are considerably more expensive than systems without centralized control. Additionally, most central control systems require planning, engineering and programming specific to the setup of the system.

Consequently, a need remains in the industry for an improved control of aggregate processing systems which provides for reduced worker movement between and in close proximity to the machines, reduced programming to accommodate reconfigurations of the system, and/or reduced cost of control systems.

### SUMMARY OF THE INVENTION

An object of the invention is to provide reconfigurable aggregate processing system which requires reduced movement of a system operator from one machine to another in the system to start up, shut down or do electrical troubleshooting of the system.

It is a feature of the present invention to include a plurality of processing plants which are free of a direct control connection to a common central control hub and instead have control lines directly connecting adjacent processing plants.

It is an advantage of the present invention to avoid the expense of a hub and spoke configuration of a common central control system.

Another object of the present invention is to provide a method of reconfiguring an aggregate processing system with reduced expense.

It is another feature of the present invention to include a system which is free of any master control unit and free of any slave control units.

It is another advantage of the present invention to provide a system which can be reconfigured without the need to utilize a programmer to reprogram the operation of the system. Additionally, one of the bigger advantages is that every plant has its own “brain” and more or less thinks for itself. This means that there is no one controller that could be considered critical to the system. If any one of them dies or malfunctions every other functioning plant can recognize and react to that without waiting for permission or instructions from a master. This makes the system very resilient against any single controller failure or an overall communications loss, even more than some preplanned central control setups.

Other and further objects of the invention, together with the features of novelty appurtenant thereto, may appear in the detailed description and the drawings.

### BRIEF DESCRIPTION OF THE DRAWINGS

In one embodiment, the present invention comprises multiple crushers/screens which utilize on-board conveyors and further have multiple common feed and discharge points across the various multiple crushers/screens.

In the following description of the drawings, in which like reference numerals are employed to indicate like parts in the various views:

FIG. 1 is a block diagram view of the Standard Device Node IDs of the present invention.

FIG. 2 is a block diagram view of a system of the present invention showing progress of self configuration in a multi-plant operation.

FIG. 3 is a block diagram view of a system of the present invention showing progress of self configuration in a standalone operation.

FIG. 4 is a block diagram view of interlock assignments of a system of the present invention in a multi-plant operation.

FIG. 5 is a program information flow diagram map of the present invention.

FIG. 6 is an optimization information flow diagram of the present invention.

FIG. 7 is an HMI screen navigation diagram of the present invention.

FIGS. 8-15 are screen layouts of the present invention.

### DETAILED DESCRIPTION OF THE DRAWINGS

1.1 Purpose

The Purpose of this Function Design Specification is to explain the design, functionality and the constraints of the present invention.

1.2 Inventor Names

See Table 1.

TABLE 1
Inventor names
Name

EDWIN J. SAUSER
JOHN SULLIVAN
KEVIN MCDERMOTT
PAYTON SCHIRM

### SUMMARY

1.3 Background

The intent of this project is to create a controls product that allows the end user to take any group of mobile plants and allow them to function as a complete system. On some current systems, for an operator to commence crushing operations, the operator has to walk to every single plant and activate it. Depending on the size of the spread, this can be time consuming and precludes the operator from having control of the entire spread at any one point. With the envisioned system, it is possible to reduce the entire spread startup process down to a single point of operation. In addition, when our system is properly used, it would allow for plants to be interlocked automatically.

In addition to automatic startup and shutdown, the existence of the communications network allows for the sharing of analog data between plants. This could allow for a plant somewhere in the spread to adjust it feed rate base on data from a plant somewhere else in the spread.

### Architecture

1.4 Hardware Architecture

The system will consist of an IFM CR2532 controller, commercially available for purchase from ifm which can be found at www.ifm.com, or a suitable substitute and an IFM CR0451, or a suitable substitute, for an operator interface. The controller contains therein a programmable logic controller (PLC) and associated hardware, which will be the same for all plant designs and for all plants in any given aggregate processing system.

1.4.1 System Requirements
1 No. IFM CR2532 Programmable Mobile Controller
1 No. IFM CR0451 Basic Display

1.4.2 Communication Interface

Communication is via embedded Controller Area Network (CAN) channel 1 on the CR0451 and CR2532 for on plant communication and CAN 2 channel 2 on the CR2532 for off plant communication.

1.4.3 Inputs/Outputs

1.4.3.1 CR2532 Mobile Controller

1.4.3.1.1 PLC ST Inputs

See Table 2.

TABLE 2
PLC ST Inputs

| | Pin | Ability | Assignment | Signal |
|---|---|---|---|---|
| VBBS | 10 | | CONTROLLER POWER | 24 V+ |
| VBBS1 | 19 | | OUTPUT POWR (0-7) | 122 |
| VBBS2 | 1 | | OUTPUT POWER (8-15) | 123 |
| GND | 20, 37, 42 | | GROUND | PE |
| IN00 | 55 | AI | VFD SPEED INPUT (NA?) | 163 |
| IN01 | 36 | AI | MATERIAL SENSOR | 164 |
| IN02 | 54 | AI | OPTIMIZATION SENSOR | 165 |
| IN03 | 35 | AI | AMPERAGE SENSOR | 166 |
| IN04 | 53 | DI/RI | PLANT ID 1 | |
| IN05 | 34 | DI/RI | PLANT ID 2 | |
| IN06 | 52 | DI | ESTOP OK | 121 |
| IN07 | 33 | DI | CRUSHER RUNNING | 200 |
| IN08 | 24 | DI | DS INTERLOCK | 132 |
| IN09 | 41 | DI | DEVICE 1 RUNNING | 201 |
| IN10 | 23 | DI | DEVICE 2 RUNNING | 202 |
| IN11 | 40 | DI | DEVICE 3 RUNNING | 203 |
| IN12 | 22 | DI/FI | DEVICE 4 RUNNING | 204 |
| IN13 | 39 | DI/FI | DEVICE 5 RUNNING | 205 |
| IN14 | 21 | DI/FI | DEVICE 6 RUNNING | 206 |
| IN15 | 38 | DI/FI | DEVICE 7 RUNNING | 207 |

1.4.3.1.2 PLC ST Outputs

See Table 3.

TABLE 3
PLC ST Outputs

| Outputs | Pin | Ability | Assignment | Signal |
|---|---|---|---|---|
| CAN 1 H | 47 | CAN 1 HIGH | ON PLANT NETWORK H | 150 |
| CAN 1 L | 29 | CAN 1 LOW | ON PLANT NETWORK L | 151 |
| CAN 2 H | 46 | CAN 2 HIGH | OFF PLANT NETWORK H | 152 |
| CAN 2 L | 28 | CAN 2 LOW | OFF PLANT NETWORK L | 153 |
| OUT00 | 18 | DO/PWM | HORN OUTPUT | 222 |
| OUT01 | 17 | DO/PWM | US INTERLOCK | 232 |
| OUT02 | 16 | DO/PWM | RUN CRUSHER | 100 |
| OUT03 | 15 | DO/PWM | RUN DEVICE 1 | 101 |
| OUT04 | 14 | DO/PWM | RUN DEVICE 2 | 102 |
| OUT05 | 13 | DO/PWM | RUN DEVICE 3 | 103 |
| OUT06 | 12 | DO/PWM | RUN DEVICE 4 | 104 |
| OUT07 | 11 | DO/PWM | RUN DEVICE 5 | 105 |
| OUT08_A | 25 | AO (0-10 V) | VFD SPEED OUTPUT | 253 |
| OUT09_A | 43 | AO (0-10 V) | | 254 |
| OUT10 | 4 | DO/PWM | RUN DEVICE 6 | 106 |
| OUT11 | 5 | DO/PWM | RUN DEVICE 7 | 107 |
| OUT12 | 6 | DO | RUN DEVICE 8 | 108 |
| OUT13 | 7 | DO | RUN DEVICE 9 | 109 |
| OUT14 | 8 | DO | RUN DEVICE 10 | 110 |
| OUT15 | 9 | DO | RUN DEVICE 11 | 111 |

1.4.3.1.3 PLC EX Inputs

See Table 4.

TABLE 4
PLC Ex Inputs

| Inputs | Pin | Ability | Assignment | Signal |
|---|---|---|---|---|
| VBBS | 10 | | CONTROLLER POWER | 24 V+ |
| VBBS1 | 19 | | OUTPUT POWR (0-7) | 124 |
| VBBS2 | 1 | | OUTPUT POWER (8-15) | 125 |
| GND | 20, 37, 42 | | GROUND | PE |
| IN16 (00) | 55 | AI | 2^{ND} AMPERAGE SENSOR | 157 |
| IN17 (01) | 36 | AI | | |
| IN18 (02) | 54 | AI | | |
| IN19 (03) | 35 | AI | DS AUTOCONFIG IN | 178 |
| IN20 (04) | 53 | DI/RI | START BUTTON | 130 |
| IN21 (05) | 34 | DI/RI | STOP BUTTON | 131 |
| IN22 (06) | 52 | DI | DEVICE 8 RUNNING | 208 |
| IN23 (07) | 33 | DI | DEVICE 9 RUNNING | 209 |
| IN24 (08) | 24 | DI | DEVICE 10 RUNNING | 210 |
| IN25 (09) | 41 | DI | DEVICE 11 RUNNING | 211 |
| IN26 (10) | 23 | DI | DEVICE 12 RUNNING | 212 |
| IN27 (11) | 40 | DI | DEVICE 13 RUNNING | 213 |
| IN28 (12) | 22 | DI/FI | DEVICE 14 RUNNING | 214 |
| IN29 (13) | 39 | DI/FI | DEVICE 15 RUNNING | 215 |
| IN30 (14) | 21 | DI/FI | DEVICE 16 RUNNING (FEEDER) | 216 |
| IN31 (15) | 38 | DI/FI | CONE CONTROLS PERMISSIVE | 217 |

1.4.3.1.4 PLC EX Outputs

See Table 5.

TABLE 5
PLC Ex Outputs

| Outputs | Pin | Ability | Assignment | Signal |
|---|---|---|---|---|
| CAN 1 H (00) | 47 | CAN 1 HIGH | | |
| CAN 1 L (00) | 29 | CAN 1 LOW | | |
| CAN 2 H (00) | 46 | CAN 2 HIGH | ON PLANT NETWORK H | 150 |
| CAN 2 L (00) | 28 | CAN 2 LOW | ON PLANT NETWORK L | 151 |
| OUT16 (00) | 18 | DO/PWM | RUN DEVICE 12 | 112 |
| OUT17 (01) | 17 | DO/PWM | RUN DEVICE 13 | 113 |
| OUT18 (02) | 16 | DO/PWM | RUN DEVICE 14 | 114 |
| OUT19 (03) | 15 | DO/PWM | RUN DEVICE 15 | 115 |
| OUT20 (04) | 14 | DO/PWM | RUN DEVICE 16 (FEEDER) | 116 |
| OUT21 (05) | 13 | DO/PWM | CONE CONTROLS RUN CMD | 117 |
| OUT22 (06) | 12 | DO/PWM | DS AUTOCONFIG OUT | 179 |
| OUT23 (07) | 11 | DO/PWM | | |
| OUT24_A (08) | 25 | AO (0-10 V) | | |
| OUT25_A (09) | 43 | AO (0-10 V) | | |
| OUT26 (10) | 4 | DO/PWM | | |
| OUT27 (11) | 5 | DO/PWM | | |
| OUT28 (12) | 6 | DO | CONE CONTROL RESET (ACE) | 98 |
| OUT29 (13) | 7 | DO | | |
| OUT30 (14) | 8 | DO | | |
| OUT31 (15) | 9 | DO | DEVICE RECOGNITION | 333 |

1.4.3.2 Standard Device Node IDs

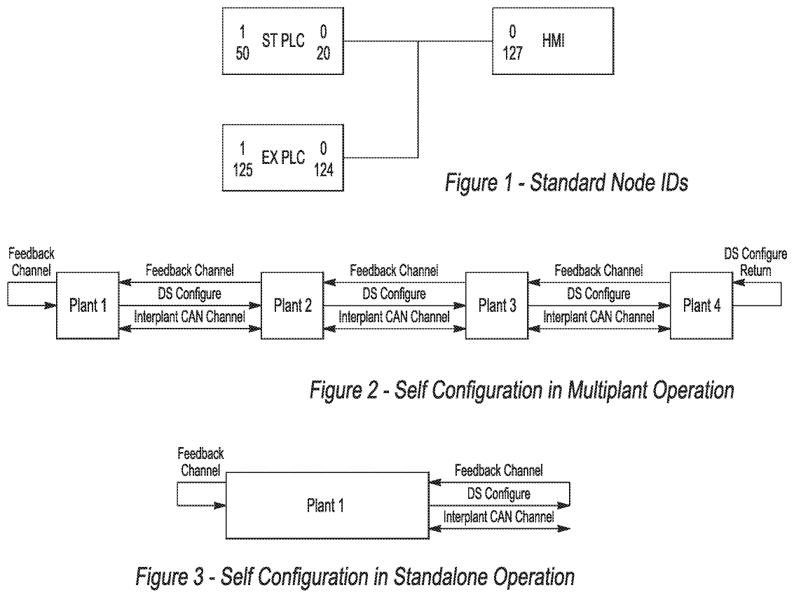

See FIG. 1.

### Solution Overview

1.5 System Functions

1.5.1 Control Philosophy

One of the key requirements that determine our approach is the requirement for common software between all controllers, regardless of what plant they are controlling. In order to achieve this level of generalization for a system for a spread of unknown scope and scale in the simplest manner possible, we have elected to take what we are calling a distributed intelligence approach. In this approach, we assume a linear arrangement, and no plant assumes the role of master controller. Instead we use the user assigned hierarchy to determine a cycle of communication. Each plant then broadcasts a status message onto the network. Each plant monitors the status of all the other plants in the spread. Using this information, individual plants make decisions on what to start up and how to react to faults. This approach simplifies some of the higher level programming, allows the operation of individual plants to be more uniform, and helps prevent the entire spread from becoming non-functional from the loss of a single controller. In addition, the distribution of intelligence will easily allow individual plants to function independently.

1.5.1.1 Description of Communication Cycle

Each communications cycle will begin by each plant broadcasting its state matrix in order of hierarchical precedence. The position in the communications hierarchy is set when the spread is initially commanded to auto configure. During this cycle, each PLC receives the state of every other plant in the spread and the state of any analog sensor in the spread. This allows each unit to have a complete picture of what the spread is doing and then react to it on an individual basis.

1.5.2 Function—Communications

One of the limitations of a CAN based control system spread over a network with the physical size of a typical spread is that the data rate can be limited. Given that each plant must communicate, the most efficient we can get is to use one CAN message per plant per communication cycle. The standard CAN communication block allows for eight bytes of data. The efficiency goal effectively gives us eight bytes for a status message. Table 6 shows the arrangement of the status message.

1.5.3 Self-Configuration Procedure

In order to simplify the setup, the CCM will be designed to self-configure. Once all the plants are connected in series, the operator will tell the system to configure by holding the “ok” button on the Network Status screen, on the HMI on the primary plant. The primary will then identify itself as plant 1. It will then immediately send out a status message identifying itself and telling the rest of the spread to be prepared to configure. After a short delay, it sends downstream (DS) configuration signal on a hardwire connection. Plant 2 then receives this signal and identifies itself as plant 2. Once it has self-identified, it sends out a DS configure signal. The process then repeats until it gets down to the last plant. The last plant will send out a DS configuration like all the previous plants, except in this case, a jumper plug will loop the signal back through the communication cable all the way to the first plant. The first plant, having already established its identity, will broadcast a setup complete message on the interplant CAN channel, and the spread will begin communication using the normal communications cycle.

Note that this auto-configuration operation is a closed loop procedure. The operation is terminated by the DS configure signal returning to the initial plant. In the event that the signal does not return within a set amount of time, the auto-configuration sequence time out, the initial plant broadcasts a message to indicate a failed configuration and the spread will not start until it has been properly configured. If any of the plants do not receive a post configuration confirmation, they will assume a faulty startup and not run until configured.

As the final step in the configuration process, each plant will sound its horn for a 0.5 second duration in the order that each plant will start. This gives the operator feedback to know that the spread is ordered correctly.

The operator steps for configuration in standalone mode will be identical to a spread configuration. In this case, the DS configure will be wired using jumper plugs back into the feedback input. Once a plant is configured, it's ID and the size of the spread will be stored as retained data in order to be accessible after a power loss.

Note: The downstream plug will be male. The upstream plug will be female.

See FIGS. 2 and 3.

1.5.4 Manual Configuration

While the auto configuration is the primary and preferred method of setting up the spread, it will also be possible to manually configure each plant. This would allow the spread to be configured if the communication method is wireless. If manually configured, the spread will only start up if there are no communication conflicts and all IDs are sequential.

1.5.5 Message Bit Assignment

CAN ID: 1248

See Table 6.

TABLE 6
Status Message Assignment

| | |
|---|---|
| STATE[0].0 | ID bit 0 |
| STATE[0].1 | ID bit 1 |
| STATE[0].2 | ID bit 2 |
| STATE[0].3 | ID bit 3 |
| STATE[0].4 | ID bit 4 |
| STATE[0].5 | ID bit 5 |
| STATE[0].6 | ID bit 6 |
| STATE[0].7 | ID bit 7 |
| STATE[1].0 | Comms Speed |
| STATE[1].1 | Comms Speed |
| STATE[1].2 | Comms Speed |
| STATE[1].3 | Comms Speed |
| STATE[1].4 | Comms Speed |
| STATE[1].5 | Comms Speed |
| STATE[1].6 | Comms Speed |
| STATE[1].7 | Comms Speed |
| STATUS[2].0 | HORN |
| STATUS[2].1 | CRUSHER |
| STATUS[2].2 | DEVICE 1 |
| STATUS[2].3 | DEVICE 2 |
| STATUS[2].4 | DEVICE 3 |
| STATUS[2].5 | DEVICE 4 |
| STATUS[2].6 | DEVICE 5 |
| STATUS[2].7 | DEVICE 6 |
| STATUS[3].0 | DEVICE 7 |
| STATUS[3].1 | DEVICE 8 |
| STATUS[3].2 | DEVICE 9 |
| STATUS[3].3 | DEVICE 10 |
| STATUS[3].4 | DEVICE 11 |
| STATUS[3].5 | DEVICE 12 |
| STATUS[3].6 | DEVICE 13 |
| STATUS[3].7 | DEVICE 14 |
| STATUS[4].0 | DEVICE 15 |
| STATUS[4].1 | DEVICE 16 |
| STATUS[4].2 | |
| STATUS[4].3 | ESTOP Status |
| STATUS[4].4 | Run Mode |
| STATUS[4].5 | Auto/Man |
| STATUS[4].6 | Startup Inhibit Active |
| STATUS[4].7 | Comms Fault Clear |
| STATUS[5].0 | Initiate Auto Configure |
| STATUS[5].1 | Terminate Auto Configure |
| STATUS[5].2 | Auto Config Master Mode |
| STATUS[5].3 | Auto Config Slave Mode |
| STATUS[5].4 | Sound Off Command |
| STATUS[5].5 | |
| STATUS[5].6 | Configured Correctly (NA?) |
| STATUS[5].7 | Upstream Enable |
| STATUS[6].0 | Heartbeat |
| STATUS[6].1 | Run Command |
| STATUS[6].2 | Stop Command |
| STATUS[6].3 | Comms Reset/Slow Comms |
| STATUS[6].4 | |
| STATUS[6].5 | |
| STATUS[6].6 | Fast Comms |
| STATUS[6].7 | Communication Reset |
| STATUS[7].0 | Fault Bit 0 |
| STATUS[7].1 | Fault Bit 1 |
| STATUS[7].2 | Fault Bit 2 |
| STATUS[7].3 | Fault Bit 3 |
| STATUS[7].4 | Fault Bit 4 |
| STATUS[7].5 | Fault Bit 5 |
| STATUS[7].6 | Fault Bit 6 |
| STATUS[7].7 | Fault Bit 7 |

1.5.6 Communications Conflicts

The controllers are currently capable of detecting communications conflicts. In the event of redundant IDs, all plants seeing communications conflicts will broadcast the presence of a communications conflict in their status message. The spread will be designed not to run if a communications conflict is present.

1.5.7 Startup/Shutdown Sequence

A start will only be initiated from the primary plant. First the warning horn would sound on all plants for 7 seconds. Once that is complete, all jaw and cone lube/hydraulic units will immediately be switched to run mode. Once all the lube/hydraulic units have been satisfied, the warning horn will sound again for 7 seconds. Then each of the crushers would start going from the furthest downstream plant to upstream plant. Once all the crushers are running, then each conveyor would start, moving from the downstream to upstream. While the spread is starting up, the warning horn should sound in intermittent burst until all devices are running. Note that the startup sequence follows the same process as the interlock sequence shown in Error! Reference source not found.

A system shutdown command can be initiated from any plant in the spread. In the event of a shutdown command, all non-crushing devices will stop immediately. All crushing devices will run for another 20 seconds to clear out any material in the chambers.

1.5.8 User Customization Options

For each device controlled by the CCM, the user will have the option to vary the startup and shutdown time using the on plant HMI. Interlocks will be predefined and will not be changeable without modifying the wiring within the panel.

1.5.9 ESTOP Operation

All panels using the CCM will have an ESTOP on the panel, as well as the ability to integrate with on plant and off plant Estops. The operation of any on plant Estops will immediately shut off power to all outputs of the panel. The CCM will continue to function and communicate, although its outputs will also be shut off. In addition, the activation of any Estop will be broadcast on the network and will be treated as equivalent to initiating a controlled stop. All non-crusher devices will shut off immediately, and all crushers will time out.

1.5.10 Interlock Operation

The system will allow all conveyors to be interlocked from downstream to upstream. If any rock carrying devices stop functioning, all upstream conveyors will immediately stop in order to prevent damage or spillage. All plants will also monitor the communications of all other plants in the spread. In the event that a plant stops communicating, all upstream conveyors will stop. In the event of a fault that causes any device in the spread to shut down, the restart will be enabled only once all of the following conditions are met: First the fault condition itself must be cleared. Second, the fault must be acknowledged at the plant where it occurred. Third, a restart must be manually initiated from the primary plant. Finally the warning horn will sound for seven seconds, then start up on any shut off devices will commence according to start sequence.

Note: Crushers will not be interlocked and will not shut down if a downstream crusher faults.

1.5.10.1 Interlock Arrangement

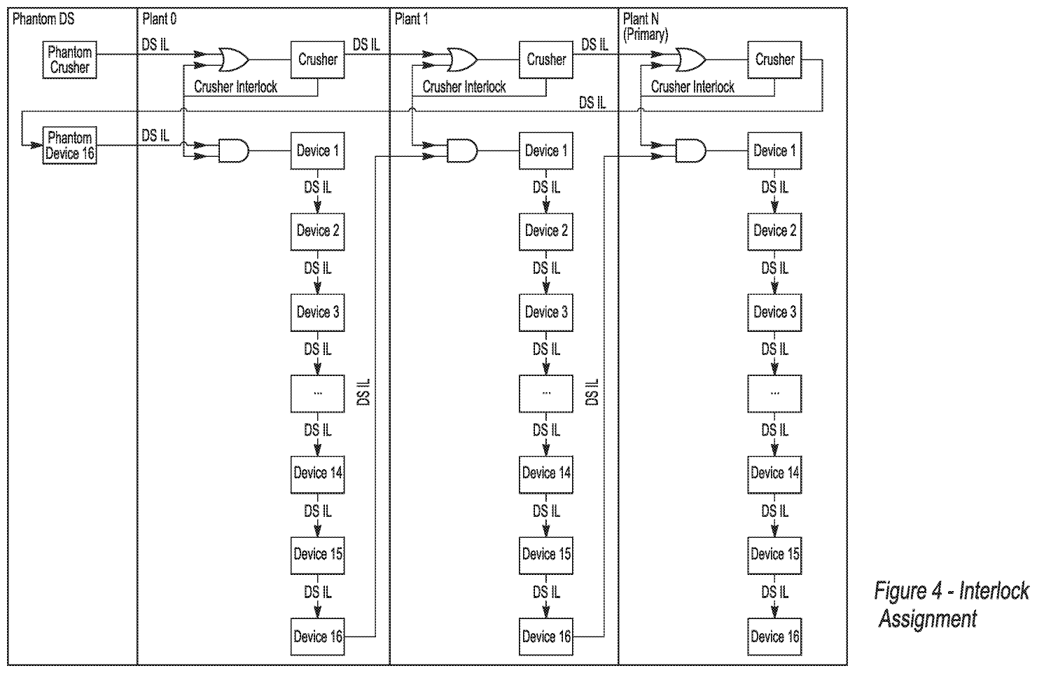

See FIG. 4.

1.5.11 Topology of Information Flow

The program of the generalized controller is built around the interplant communications cycle. The flow of information starts with receiving a status message on the interplant CAN network. Each message is then sorted into a state array, which is used to track the status of the plant. Information in the state array is then further sorted into an upstream state and a downstream state. These states are used to drive the Operational Logic section. The Operational Logic section looks at physical inputs, inputs from the remote module, as well as the state of the upstream and downstream. The Operational Logic then uses this information to set the state of the outputs. Physical outputs are fired directly. Remote outputs are fired through the on-plant CAN network. The state of the outputs as well as any fault codes are loaded into the plants status message, and transmitted at the appropriate point in the communications cycle.

1.5.11.1 Information Flow Diagram

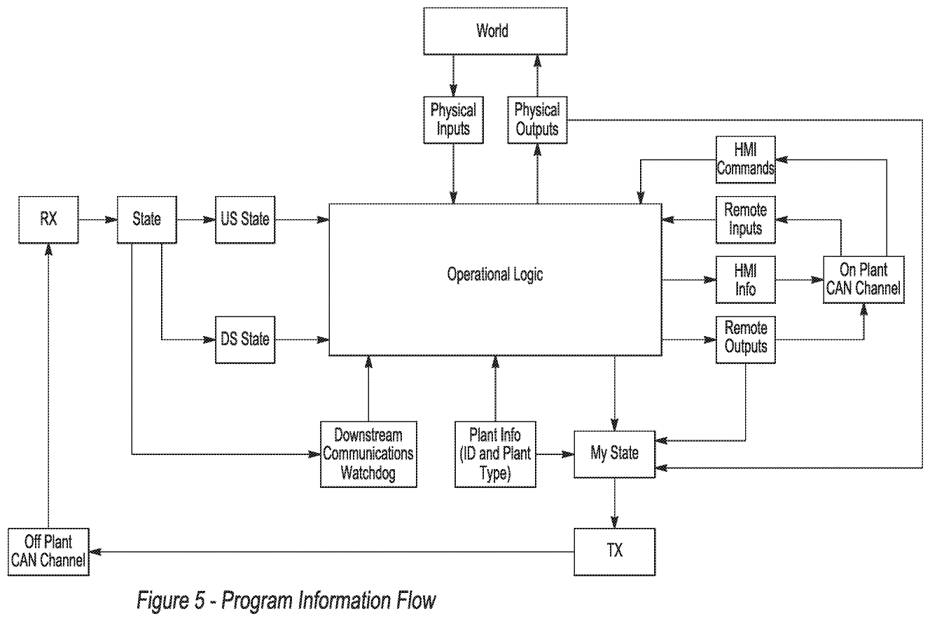

See FIG. 5.

1.5.12 Optimization Overview

Every system will have the ability to control a variable speed feeder on a plant. Each plant will also have the ability to receive and transmit information from up to three analog sensors. These sensors will be preset as material presence sensor, an optimizing sensor, and a current sensor. As part of the communication cycle, each plant will transmit the state of its analog inputs. The last message from each plant will be stored in an array. Each plant will be able to vary its feeder speed according to the input of any other plant in the spread. This will allow each customer to optimize his spread based on his individual setup.

Analog information can also be used as a permissive for devices in the maintenance menu whether or not it is dependent on a MP sensor, and which sensor will act as a permissive.

1.5.12.1 Optimization Requirements

For an optimization to occur, there are a few conditions that need to be met. First we assume the presence of a process we wish to control. Given the process exists, we also assume that we have some method for monitoring it, such as a level sensor in this case. Each controller has I/O space of up to three analog inputs. Each of these inputs is transmitted onto the network with two byte precision as part of the normal communications cycle. This will allow any plant in the spread to optimize its variable output based on any sensor being monitored. Also, to optimize this process we need some method of affecting it, such as an upstream feeder driven by a VFD in this case. Every controller, will have the ability to drive at least one analog output, thereby allowing them to drive at least one process effector. Finally, we assume the presence of two controllers, one upstream and one downstream, that are able to communicate. The one upstream in the process controls the manipulator and is referred to as the optimizing controller. The downstream controller monitors the process and is referred to as the monitoring controller. The aforementioned communication protocol will allow them to share information, thereby fulfilling the communication requirement.

Note that it will be possible for a single controller to adapt to both roles, but this does not alter the control algorithm.

1.5.12.2 Optimization Process

The bulk of the optimization process occurs in the optimizing controller. It starts with the controller being given a known set point for optimization. The controller could be given this set point by manual entry via on-plant HMI, or by recording a value from a sensor that it is monitoring. Once the set point is determined, it is compared to a process signal received from some sensor connected to the spread. This error signal is then fed through a Process Control System (PCS). The control constants of this PCS will be set by the user through the HMI. The PCS control signal will then be sent through the analog output to whatever process effector is in use.

In order to prevent optimization errors due to non-linear events in the process, (such as a feeder feeding with no material) the optimization system will make use of a material sensor. The material sensor will feed its signal, either directly or indirectly, to the optimizing controller. The controller then activates the PCS after a user defined time delay.

The initial design will include two PCS solutions which can be switched at will. One option will be to use a PID.

PID (Proportional, Integral and Derivative): One control option will be to use an industry standard PID control block to stabilize the bin level. The disadvantage of this option is that few individuals on the operations side of this business will have the necessary skillset to tune the system properly. There may be some approximations that can be made in order to simplify the tuning process and ease the burden on the field side.

DETPOCS (Discreet Evaluated Process Optimization and Control Solution): An alternative control solution will also be implemented. The DETPOCS is roughly equivalent in complexity to implement, and possibly simpler to tune. Its possible drawbacks are it is yet unproven in performance and stability.

In between the effector and the optimizing sensor, some external process occurs. For the most part, this is going to involve material flow and surge bins, which will probably translate into first or second order models with some time delay.

Finally the optimizing sensor will observe the result of the process and transmit it to the monitoring controller via the analog input. The monitoring controller will broadcast its sensor values on the interplant network. This broadcast is monitored by the optimizing controller, continuing the cycle.

1.5.12.3 Optimization Information Flow

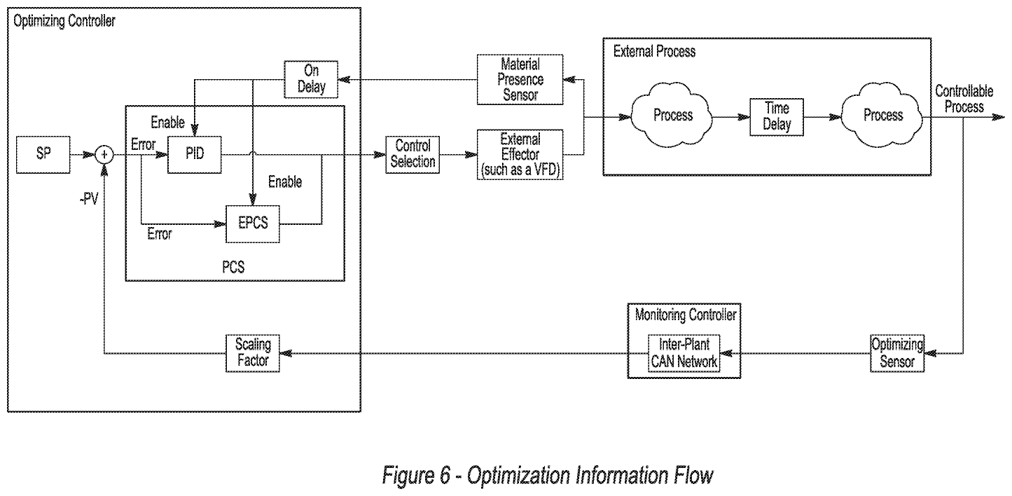

See FIG. 6.

1.5.12.4 Analog Information Status Message

See Table 7.

TABLE 7
Analog Message Assignment

| ! | Plant ID |
|---|---|
| Byte 1 | Reserved |
| Byte 2 | Sensor 1 Byte 1 |
| Byte 3 | Sensor 1 Byte 2 |
| Byte 4 | Sensor 2 Byte 1 |
| Byte 5 | Sensor 2 Byte 2 |
| Byte 6 | Sensor 3 Byte 1 |
| Byte 7 | Sensor 3 Byte 2 |

1.5.13 Manual Functions

1.5.13.1 Enable/Disable

As part of the requirements for the project, any motor will be able to be enabled or disabled from the sequence. Disabling a component means that it will not start up during the startup sequence. Its interlock is effectively bypassed so all upstream devices are still interlocked to any active devices downstream of the disabled device. Devices will be enabled and disabled by the user from the HMI. The controller will be required to retain this information between power cycles.

1.5.13.2 Hardware Disable Option

As the design is very general and designed to be adaptable to multiple plants, it is necessary to change the configuration of a plant. In addition, the CCM will be designed to auto configure as the spread performs its initial setup. All inputs for non-existent devices are hooked up to a dedicated output on the CCM. When the plant auto-configures, it sends out a pulse through the dedicated configuration output. All devices that pulse high with the configuration output, will be automatically disabled. Once this is complete, any additional modifications to the setup can be made through the HMI. Hardware auto configure can be configured by holding the “ok” button for 5 seconds on the maintenance screen.

1.5.13.3 Run/Stop

While the spread is not running, individual devices may be activated manually for maintenance purposes. In addition, disabled devices may be activated as well while the spread is running. Note that devices activated in this manner will not be interlocked to any device, or have any devices interlocked to them.

1.5.13.5 Jog Function

For brief operation, devices may be jogged from the same menu in a similar manner. The only differences between jogging and running a motor manually will be the requirement for the user to hold down a button while the motor is running. This functionality could be removed from the COMMON CONTROL MODULE.

1.5.13.5 Auxiliary Functionality

All devices will be able to be categorized as either auxiliary function 1 or 2. When a device is tied to an auxiliary function, that means it can be toggled using the auxiliary button on the radio remote.

1.5.14 Downstream/Upstream Functionality

Although this feature will not be used between CCM controllers, the CCM will be designed with downstream and upstream interlock functionality in order to integrate with legacy and non-Terex plants. The upstream interlock will be a normally open contact that will signal the plant is ready to receive material. The downstream interlock will be closed through a jumper plug in normal operation. If an off plant conveyor is connected, this signal will be run in series through auxiliary contacts on all off plant devices. Any break in this signal will shut down all conveyors on-plant.

1.6 HMI Specifications

1.6.1 Purpose

Each CCM panel will utilize an on-plant HMI to set parameters and monitor faults and information on the plant. The intent of the display is to make the interface as simple as possible while allowing the user to access all of the necessary information. FIG. 4 shows the intended HMI screen navigation map.

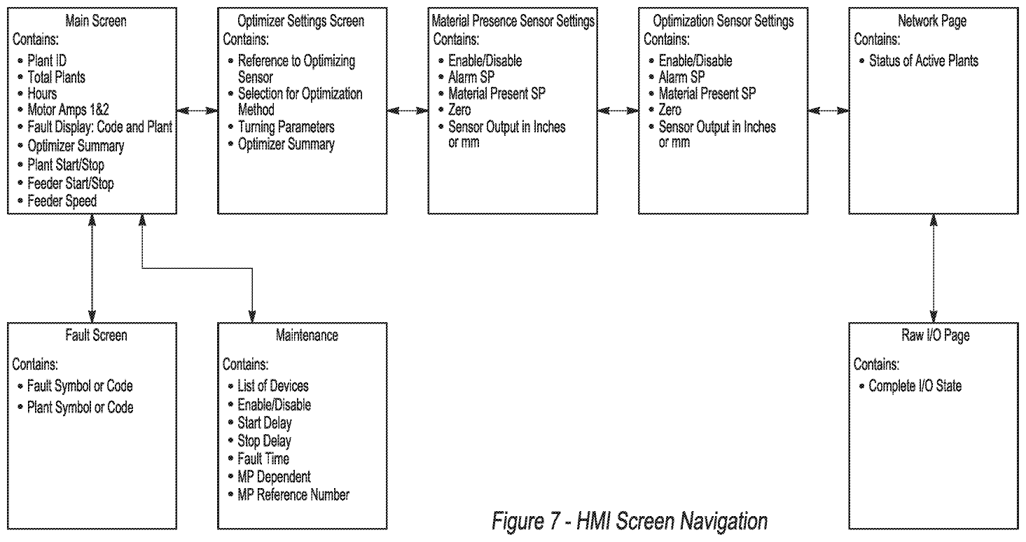

See FIG. 7.

1.6.2 HMI Communication

The HMI will communicate to the CCM via the on-plan CAN channel.

1.6.3 Screens

1.6.3.1 Main Screen

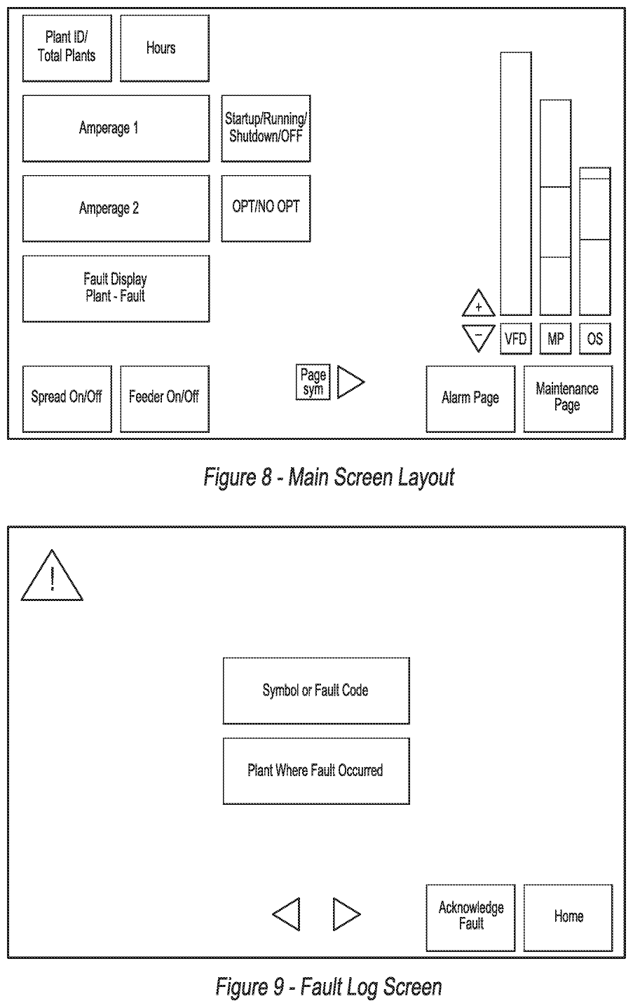

See FIG. 8, where the main screen is intended to be the default screen that the operator interacts with. From here, the operator can view all of the information relevant to the operation of the plant, such as hours, amps, sensor information, feeder speed. In addition, the operator can start the spread if they are at plant 1 and stop the spread from any plant.

In addition, if the plant has a variable feed device, the feeder will be adjustable using the arrow keys from this screen. The user will be able to navigate the Optimization and Settings page, the Maintenance Functions page, and fault log from here. The Feeder on/off button can be held for 5 seconds to disable all feeders in the spread.

1.6.3.2 Fault Screen

See FIG. 9, where the fault log screen will store a list of faults that have occurred. The system will store the fault, the plant on which it occurred, and the machines hours at the time of the fault. The user will be able to scroll through the faults using the left and right arrow keys.

1.6.3.3 Maintenance Functions Screen

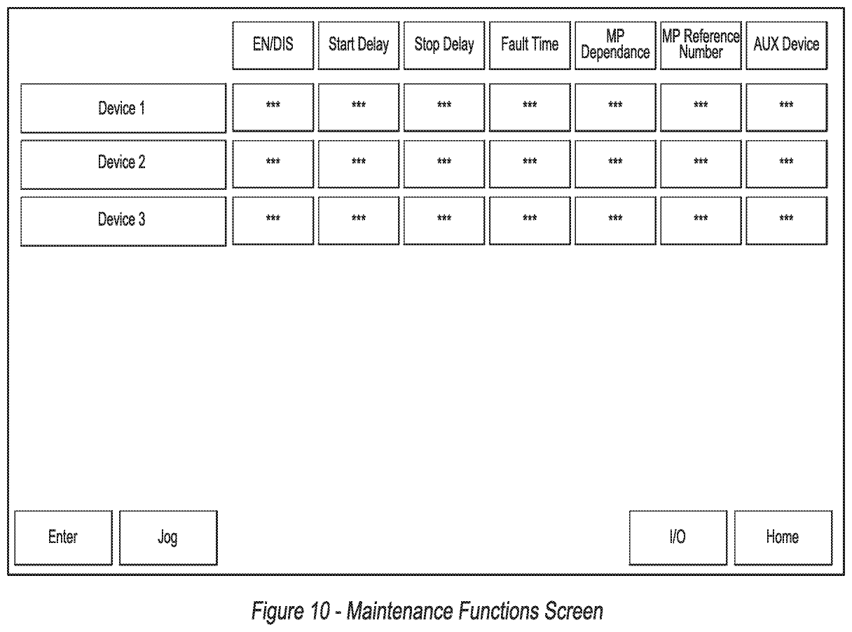

See FIG. 10, where from the maintenance screen, the operator will be able to enable and disable individual devices, jog individual motors, run individual motors manually, select whether to enable them using a material presence sensor, and customize other parameters such as start time, stop time, and fault time, and whether the motor functions as an auxiliary device.

1.6.3.4 Optimization Settings Screen

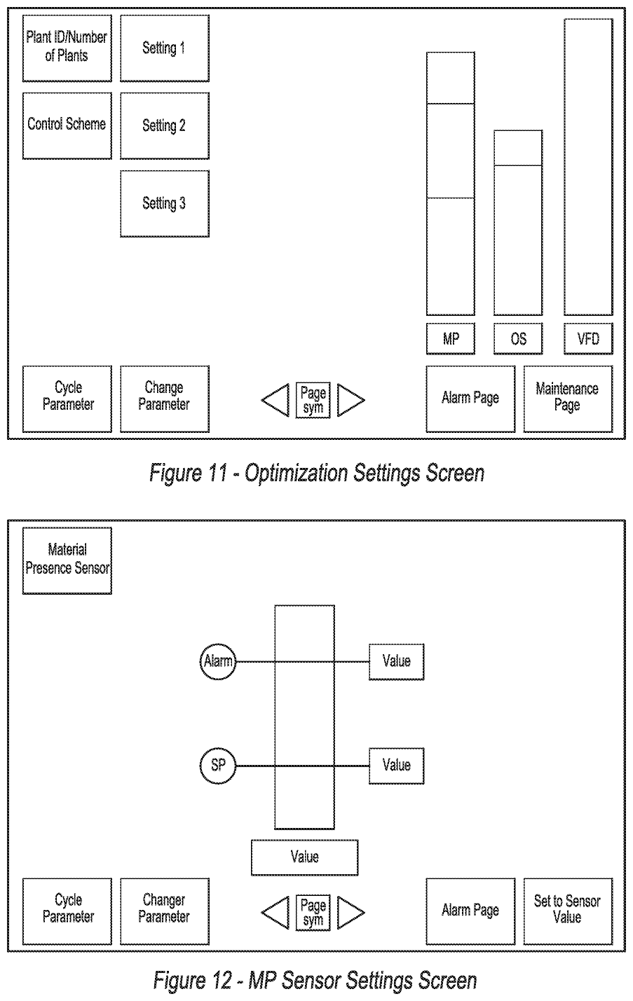

See FIG. 11, where the optimization settings page displays an overview of the CCMs optimizer, allows the PCS to be selected, and allows the tuning parameters of the selected PCS to be adjusted.

1.6.3.5 MP Sensor Settings Screen

See FIG. 12, where the Material Presence sensor settings page will can be used to adjust the alarm, set point, and zero values. Set points can be entered manually or set to the current sensor value.

1.6.3.6 OS Sensor Settings Screen

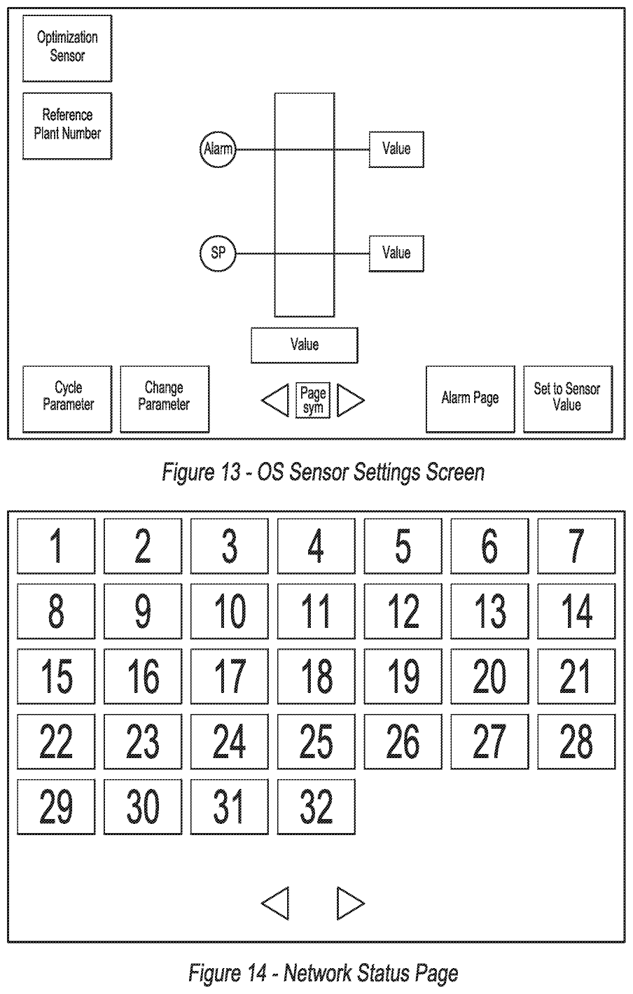

See FIG. 13, where the Optimization sensor settings page can be used to adjust the alarm, set point, and zero values. Set points can be entered manually or set to the current sensor value.

1.6.3.7 Network Status Page

See FIG. 14, where the network status page shows the state of all CCM on the interplant network.

1.6.3.8 Raw I/O Page

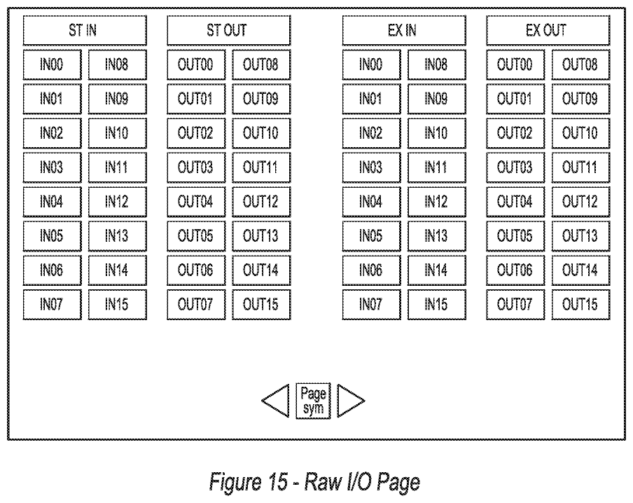

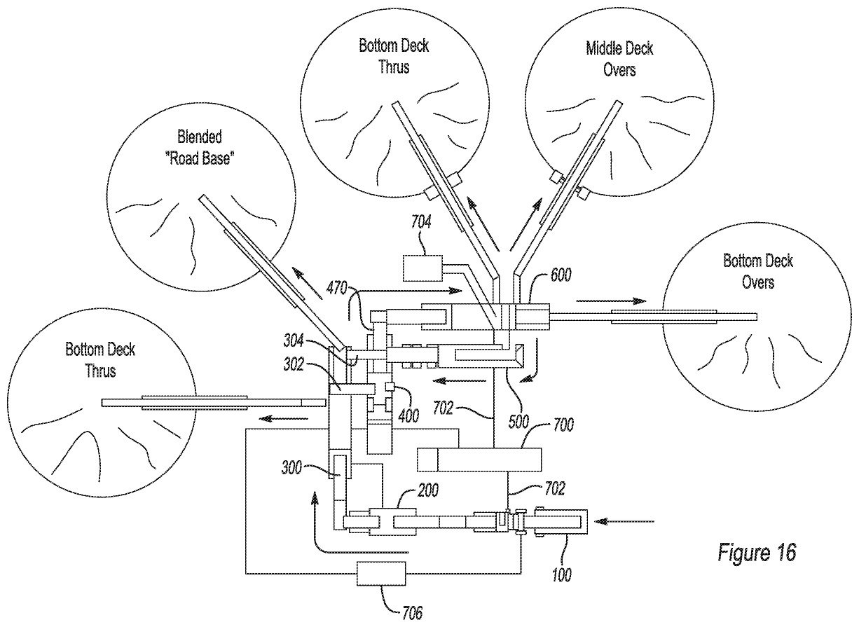

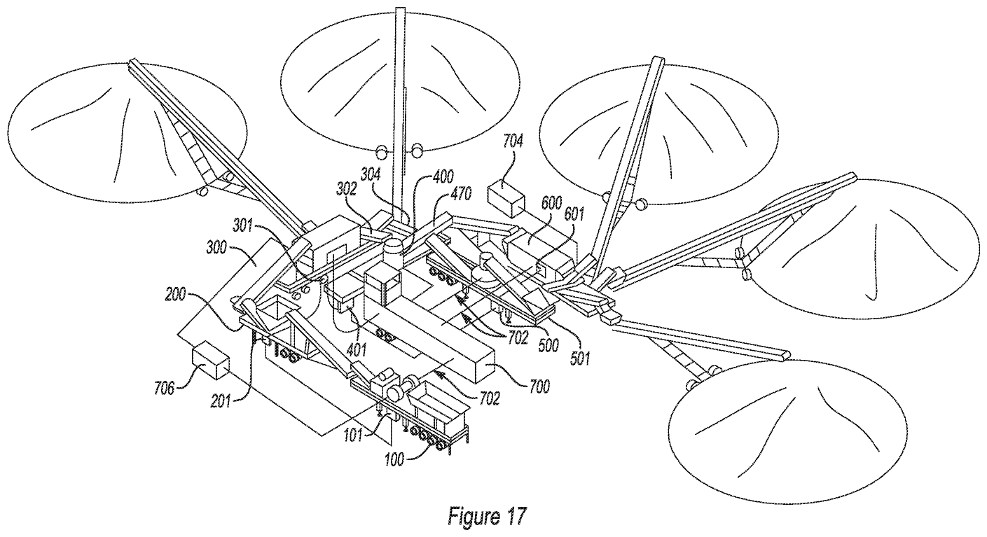

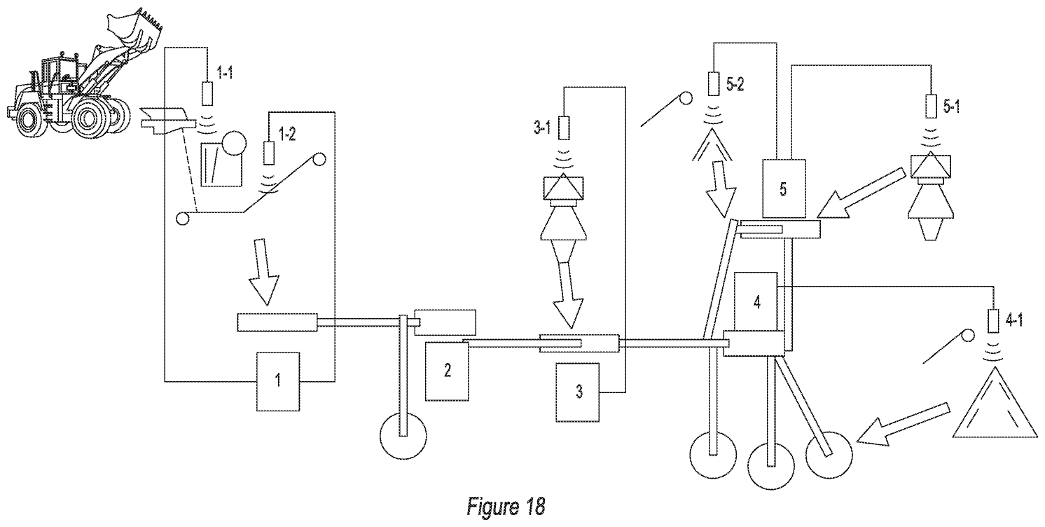

See FIG. 15, where the raw I/O page will show the state of all the local I/O.

1.7 Fault Handling

1.7.1 On Plant Faults

The vast majority of the faults in this system involve the malfunction of a particular device. In the event of a device malfunction, all interlocked devices, as defined in Error! Reference source not found., will shut off immediately. A two part fault code will be displayed on the HMI that will indicate both the plant with the fault and the nature of the fault, as shown in Table 8. In the event of multiple faults, only the initial fault will be displayed on the HMI.

In the event of an optimization or material presence sensor communications loss, a fault will be displayed to alert the operator. Optimization mode will shut off and will not be able to be reactivated until both sensors have had their functionality restored.

1.7.2 Fault Communication

Faults will be transmitted on the interplant communication network as part of the CCM's regular status message. The most prevalent fault code will be transmitted in byte 8 of the status message. (see Table 6) Fault codes will be communicated according to the standard shown in Table 8.

See Table 8

TABLE 8
Error Code Assignment

| Fault | Fault Code | | |
|---|---|---|---|
| Number | (Binary) | Fault Description | Fault Explanation |
| 0 | 00000000 | No Fault Present | This code indicates there are no faults on the |
| | | | device. |
| 1 | 00000001 | Device 1 Fail to Run | Controller has sent a run command to Device 1 |
| | | | and has not received a return feedback within the |
| | | | allotted time. This may indicate a tripped |
| | | | protection device, failed contactor, broken wire, |
| | | | or improper configuration. |
| 2 | 00000010 | Device 2 Fail to Run | Controller has sent a run command to Device 2 |
| | | | and has not received a return feedback within the |
| | | | allotted time. This may indicate a tripped |
| | | | protection device, failed contactor, broken wire, |
| | | | or improper configuration. |
| 3 | 00000011 | Device 3 Fail to Run | Controller has sent a run command to Device 3 |
| | | | and has not received a return feedback within the |
| | | | allotted time. This may indicate a tripped |
| | | | protection device, failed contactor, broken wire, |
| | | | or improper configuration. |
| 4 | 00000100 | Device 4 Fail to Run | Controller has sent a run command to Device 4 |
| | | | and has not received a return feedback within the |
| | | | allotted time. This may indicate a tripped |
| | | | protection device, failed contactor, broken wire, |
| | | | or improper configuration. |
| 5 | 00000101 | Device 5 Fail to Run | Controller has sent a run command to Device 5 |
| | | | and has not received a return feedback within the |
| | | | allotted time. This may indicate a tripped |
| | | | protection device, failed contactor, broken wire, |
| | | | or improper configuration. |
| 6 | 00000110 | Device 6 Fail to Run | Controller has sent a run command to Device 6 |
| | | | and has not received a return feedback within the |
| | | | allotted time. This may indicate a tripped |
| | | | protection device, failed contactor, broken wire, |
| | | | or improper configuration. |
| 7 | 00000111 | Device 7 Fail to Run | Controller has sent a run command to Device 7 |
| | | | and has not received a return feedback within the |
| | | | allotted time. This may indicate a tripped |
| | | | protection device, failed contactor, broken wire, |
| | | | or improper configuration. |
| 8 | 00001000 | Device 8 Fail to Run | Controller has sent a run command to Device 8 |
| | | | and has not received a return feedback within the |
| | | | allotted time. This may indicate a tripped |
| | | | protection device, failed contactor, broken wire, |
| | | | or improper configuration. |
| 9 | 00001001 | Device 9 Fail to Run | Controller has sent a run command to Device 9 |
| | | | and has not received a return feedback within the |
| | | | allotted time. This may indicate a tripped |
| | | | protection device, failed contactor, broken wire, |
| | | | or improper configuration. |
| 10 | 00001010 | Device 10 Fail to Run | Controller has sent a run command to Device 10 |
| | | | and has not received a return feedback within the |
| | | | allotted time. This may indicate a tripped |
| | | | protection device, failed contactor, broken wire, |
| | | | or improper configuration. |
| 11 | 00001011 | Device 11 Fail to Run | Controller has sent a run command to Device 11 |
| | | | and has not received a return feedback within the |
| | | | allotted time. This may indicate a tripped |
| | | | protection device, failed contactor, broken wire, |
| | | | or improper configuration. |
| 12 | 00001100 | Device 12 Fail to Run | Controller has sent a run command to Device 12 |
| | | | and has not received a return feedback within the |
| | | | allotted time. This may indicate a tripped |
| | | | protection device, failed contactor, broken wire, |
| | | | or improper configuration. |
| 13 | 00001101 | Device 13 Fail to Run | Controller has sent a run command to Device 13 |
| | | | and has not received a return feedback within the |
| | | | allotted time. This may indicate a tripped |
| | | | protection device, failed contactor, broken wire, |
| | | | or improper configuration. |
| 14 | 00001110 | Device 14 Fail to Run | Controller has sent a run command to Device 14 |
| | | | and has not received a return feedback within the |
| | | | allotted time. This may indicate a tripped |
| | | | protection device, failed contactor, broken wire, |
| | | | or improper configuration. |
| 15 | 00001111 | Device 15 Fail to Run | Controller has sent a run command to Device 15 |
| | | | and has not received a return feedback within the |
| | | | allotted time. This may indicate a tripped |
| | | | protection device, failed contactor, broken wire, |
| | | | or improper configuration. |
| 16 | 00010000 | Device 16 Fail to Run | Controller has sent a run command to Device 16 |
| | | | and has not received a return feedback within the |
| | | | allotted time. This may indicate a tripped |
| | | | protection device, failed contactor, broken wire, or |
| | | | improper configuration. |
| 17 | 00010001 | Device 1 Faulty Run | The controller is receiving a feedback signal from |
| | | | Device 1 without sending a run command. This |
| | | | may indicate a faulty contactor. |
| 18 | 00010010 | Device 2 Faulty Run | The controller is receiving a feedback signal from |
| | | | Device 2 without sending a run command. This |
| | | | may indicate a faulty contactor. |
| 19 | 00010011 | Device 3 Faulty Run | The controller is receiving a feedback signal from |
| | | | Device 3 without sending a run command. This |
| | | | may indicate a faulty contactor. |
| 20 | 00010100 | Device 4 Faulty Run | The controller is receiving a feedback signal from |
| | | | Device 4 without sending a run command. This |
| | | | may indicate a faulty contactor. |
| 21 | 00010101 | Device 5 Faulty Run | The controller is receiving a feedback signal from |
| | | | Device 5 without sending a run command. This |
| | | | may indicate a faulty contactor. |
| 22 | 00010110 | Device 6 Faulty Run | The controller is receiving a feedback signal from |
| | | | Device 6 without sending a run command. This |
| | | | may indicate a faulty contactor. |
| 23 | 00010111 | Device 7 Faulty Run | The controller is receiving a feedback signal from |
| | | | Device 7 without sending a run command. This |
| | | | may indicate a faulty contactor. |
| 24 | 00011000 | Device 8 Faulty Run | The controller is receiving a feedback signal from |
| | | | Device 8 without sending a run command. This |
| | | | may indicate a faulty contactor. |
| 25 | 00011001 | Device 9 Faulty Run | The controller is receiving a feedback signal from |
| | | | Device 9 without sending a run command. This may |
| | | | indicate a faulty contactor. |
| 26 | 00011010 | Device 10 Faulty Run | The controller is receiving a feedback signal from |
| | | | Device 10 without sending a run command. This |
| | | | may indicate a faulty contactor. |
| 27 | 00011011 | Device 11 Faulty Run | The controller is receiving a feedback signal from |
| | | | Device 11 without sending a run command. This |
| | | | may indicate a faulty contactor. |
| 28 | 00011100 | Device 12 Faulty Run | The controller is receiving a feedback signal from |
| | | | Device 12 without sending a run command. This |
| | | | may indicate a faulty contactor. |
| 29 | 00011101 | Device 13 Faulty Run | The controller is receiving a feedback signal from |
| | | | Device 13 without sending a run command. This |
| | | | may indicate a faulty contactor. |
| 30 | 00011110 | Device 14 Faulty Run | The controller is receiving a feedback signal from |
| | | | Device 14 without sending a run command. This |
| | | | may indicate a faulty contactor. |
| 31 | 00011111 | Device 15 Faulty Run | The controller is receiving a feedback signal from |
| | | | Device 15 without sending a run command. This |
| | | | may indicate a faulty contactor. |
| 32 | 00100000 | Device 16 Faulty Run | The controller is receiving a feedback signal from |
| | | | Device 16 without sending a run command. This |
| | | | may indicate a faulty contactor. |
| 33 | 00100001 | Communications Loss | This fault indicates that at least one plant in the |
| | | | spread has stopped communicating |
| 34 | 00100010 | Crusher Fail to Run | Controller has sent a run command to the |
| | | | Crusher and has not received a return feedback |
| | | | within the allotted time. This may indicate a tripped |
| | | | protection device, failed contactor, broken |
| | | | wire, or improper configuration. |
| 35 | 00100011 | Crusher Faulty Run | The controller is receiving a feedback signal from |
| | | | the Crusher without sending a run command. |
| 36 | 00100100 | Cone Fail to Run | Controller has sent a run command to the cone |
| | | | control system and has not received a return |
| | | | feedback within the allotted time. This may |
| | | | indicate a tripped protection device, failed |
| | | | contactor, broken wire, or improper |
| | | | configuration. |
| 37 | 00100101 | Cone Faulty Run | The controller is receiving a feedback signal from |
| | | | the Cone Control Package without sending a run |
| | | | command. |
| 38 | 00100110 | MS Level Fault | The level being recorded by the on plant material |
| | | | sensor has exceeded its alarm limit |
| 39 | 00100111 | MS Drop Out | If a material sensor is expected and the controller |
| | | | is not receiving at least 3.8 mA, this may indicate |
| | | | a problem with the sensor or cable. |
| 40 | 00101000 | OS Level Fault | The level being recorded by the on plant |
| | | | optimization sensor has exceeded its alarm limit |
| 41 | 00101001 | OS Drop Out | If a optimization sensor is expected and the |
| | | | controller is not receiving at least 3.8 mA, this |
| | | | may indicate a problem with the sensor or cable. |
| 42 | 00101010 | On Plant | Indicates that a plant has lost communications |
| | | Communications Fault | with one or more devices in its on plant network. |
| 43 | 00101011 | ESTOP Pushed | Indicates that the ESTOP system is pushed |
| 44 | 00101100 | ID Collision | Multiple plants are using the same ID causing a |
| | | | collision |
| 45 | 00101101 | Device 1 Trip | Indicates that device 1 has likely tripped |
| 46 | 00101110 | Device 2 Trip | Indicates that device 2 has likely tripped |
| 47 | 00101111 | Device 3 Trip | Indicates that device 3 has likely tripped |
| 48 | 00110000 | Device 4 Trip | Indicates that device 4 has likely tripped |
| 49 | 00110001 | Device 5 Trip | Indicates that device 5 has likely tripped |
| 50 | 00110010 | Device 6 Trip | Indicates that device 6 has likely tripped |
| 51 | 00110011 | Device 7 Trip | Indicates that device 7 has likely tripped |
| 52 | 00110100 | Device 8 Trip | Indicates that device 8 has likely tripped |
| 53 | 00110101 | Device 9 Trip | Indicates that device 9 has likely tripped |
| 54 | 00110110 | Device 10 Trip | Indicates that device 10 has likely tripped |
| 55 | 00110111 | Device 11 Trip | Indicates that device 11 has likely tripped |
| 56 | 00111000 | Device 12 Trip | Indicates that device 12 has likely tripped |
| 57 | 00111001 | Device 13 Trip | Indicates that device 13 has likely tripped |
| 58 | 00111010 | Device 14 Trip | Indicates that device 14 has likely tripped |
| 59 | 00111011 | Device 15 Trip | Indicates that device 15 has likely tripped |
| 60 | 00111100 | Device 16 Trip (Feeder) | Indicates that device 16 has likely tripped |
| 61 | 00111101 | Crusher Trip | Indicates that crusher has likely tripped |
| 62 | 00111110 | Cone Fault | Indicates that cone control has experienced a |
| | | | sudden fault |

1.7.3 Spread Wide Fault Handling

When the CCM is operating as part of a spread, interlocks will function identically to standalone mode on the plant where the fault occurred. All conveyors on plants upstream will stop as defined in Error! Reference source not found. The most recent active fault code and the plant number where the fault occurred will be displayed on all panels throughout the system. The fault will only clear once the fault condition has been removed, and the fault has been reset at the panel where the fault occurred.

In the event of communication loss on one of the plants, all upstream conveyors will shut down immediately. The plant that is unable to communicate will also shut down immediately. Downstream plants will continue to run.

### Miscellaneous Requirements

1.8 Cone Control Integration

In order to integrate correctly with the CCM module, all cone controls will be required to operate hardwire control. All cone controls will be required to receive a single run command from the CCM and transmit a single run permissive to the CCM via digital I/O.

1.9 Wireless Loader Remote

To allow for control from an optional loader remote, the CCM will integrate using an industrial radio, with a visual indicator to provide feedback. To coordinate with the CCM, the radio receiver will integrate as an optional CAN Open device. The radio is required to be able to transmit start/stop for the plant, start/stop/adjust speed for the feeder, and display the feeder speed. The CCM is intended to be compatible with the MJ400 radio remote option.

1.10 Wired Remote Control

In some embodiments, a wired remote for the panel may be designed to allow the controls to be placed on a panel for remote operation.

1.11 Wireless Communications Remote Control

In other embodiments, wireless remote controls may be made to communicate wirelessly to and from the wireless remote. Hardware solutions for wireless remote control are commercially available.

1.12 Settings Retention

All pertinent static settings will be stored on both the PLC and HMI. In the event that the PLC needs to be replaced, the HMI will be able to download the last stored settings. If the HMI is replaced, it will be able to request the settings from the PLC to reload. In some embodiments this feature could be omitted.

The common control module of the present invention can be used to operate an aggregate processing system as shown in FIGS. 16 and 17, where there is shown an array of product piles and a system for processing road building materials. There is shown a bifurcatable crusher 100, a surge bin material transfer apparatus 200, and scalping screen 300 and a scalping screen to secondary cone input conveyor 302 and a secondary cone bypass conveyor 304 which delivers the output of scalping screen 300 to the output of secondary cone crusher 400 without running the material through secondary cone crusher 400.

Bifurcatable crusher 100 can be a jaw crusher, such as those manufactured by Terex USA, LLC or other type, which has a significant weight which would exceed a maximum weight for a trailer to travel as one complete unit.

Scalping screen 300 may have various sized screens therein, but in one embodiment, it might have screens of the following sizes: 2.5 inches top deck, 1.25 inches middle deck, and a 0.875 inches bottom deck, all being 6′×20′. Scalping screen 300 is shown outputting two (2) stockpiles, with a total of five (5) stockpiles for the entire system, but it should be understood that one embodiment of the present invention is capable of simultaneously outputting seven stockpiles, five of which could be blended (material which is known to be separated to different size ranges and then later combined). More details of the design and operation of scalping screen 300 will be understood when referring to FIG. 10 in U.S. Pat. No. 8,162,245.

Secondary cone crusher 400 has one output conveyor, secondary cone output conveyor 470, which accepts material from three sources, the output of the secondary cone crusher 400, the secondary cone bypass conveyor 304 (at a common height), and the output conveyor of the tertiary cone crusher 500 (at a common height). In one embodiment, secondary cone crusher 400 could be an MVP-type cone crusher, as manufactured by Terex USA, LLC, with a one-inch output setting. Secondary cone output conveyor 470 feeds finish screen 600 (at a common height) which has four (4) output conveyors, three (3) of which deliver material to stockpiles and another which loops material back around via tertiary cone crusher 500 to secondary cone output conveyor 470 (at a common height) and then back through finish screen 600.

Tertiary cone crusher 500 could also be an MVP-type cone crusher and in one embodiment, could have a ½-inch output setting. Tertiary cone crusher 500 also has a common feed point height that is set to cooperate with the common output conveyor height of the scalping screen 300 and finish screen 600.

Finish screen 600 could in one embodiment be a triple deck screen with a 0.75-inch top deck, a 0.5-inch middle deck, and a 0.25-inch bottom deck, all of which could in one embodiment be an 8′×20′ screen.

With the common output conveyor heights and the common feed point heights of the various components to the system, it is possible to customize a solution for a particular specification or application. Control trailer 700 is the central control and power source for the various components. In one embodiment, the control trailer 700 may provide only control signals leaving the power supplying function to the generators 704 and 706. In another arrangement, control trailer 700 could provide both. In still other embodiments, control trailer 700 could provide power, as well as additional generators 704 and 706. Power supply and control wires 702 would connect the control trailer 700 with the various components. Having a small footprint for the system allows for short power supply lines between the control trailer 700 and the various other components. The shorter the power supply lines, the less resistance and the concomitant energy loss associated therewith. With less energy loss, a smaller generator can be used, thereby conserving fuel costs. Also, with shorter power supply lines which are typically much larger than the lines that merely provide control signals, you get less weight and easier and quicker setup times. Alternatively, each component could have its own engine/generator system and could be connected together via a wired or wireless network.

It should be noted that the system of FIGS. 16 and 17 does not have any stand-alone single purpose inter-plant conveyor trailers; i.e., each conveyor in the system of the present invention is coupled to and combined with and transported as part of a function piece of equipment which provides a function other than merely conveying material. The surge bin material transfer apparatus 200 provides the function of buffering irregular flows by temporarily storing material exiting the bifurcatable crusher 100 at times of high output flow. Additionally, in one embodiment, all of the inter-plant (between screen, crusher, and surge bin) conveyors used in the entire system are not configured to provide substantial vertical height adjustment of the discharge point. The use of such common discharge point heights from the various inter-plant conveyors enables faster setup times while preserving the ability to move the screens and crushers around to form different system configurations. One of the innovative methods of the present invention is to rearrange, add to, or omit from a first system, screens, crushers and surge bins and thereby create a different combination without making any horizontal or vertical adjustments of the any discharge points of any inter-plant conveyors. The use of common discharge and common feed points for the various screens, crusher and surge bins allows for this to occur.

The various screens, crushers, etc. are shown with wheels and tires thereon for providing the ability to transport them on a highway. However, it should also be understood that some embodiments of the present invention might include tracks instead of tires or in addition to tires. Even if the system is designed with tracks, many of the beneficial aspects of the invention are still achieved.

Now referring to FIG. 17, there are shown common control modules 101, 201, 301, 401, 501 and 601 which:

1. all can be functionally identical to each other;

2. all can be interchangeable with each other; and/or

3. any one of which can be plug and play replaceable by a single replacement CCM.

The common control modules of the present invention can be implemented in aggregate processing systems as shown in FIGS. 16 and 17. Another embodiment of the present invention can be configured so that the new control utilizes a uniquely programmed PLC that is identical in construction and programming for any type of crushing or screening machine. Because all PLCs in this new crushing and screening control system are identical, the PLC is called a Common Control Module or “CCM” for short. A CCM can be used to control multiple devices in most any type of crushing machine or screening machine along with peripheral equipment such as conveyors bringing to or taking away material from that machine. Because CCMs have identical construction and programming, they have standardized input and output signals which are designed to sequentially start, stop, and interlock devices. The CCM can send a signal to start a device and wait for return signal from that device before starting next device in the sequence. How these standardized inputs and outputs are connected to the device switchgear dictates how the CCM controls, monitors, and sequences those devices within that crushing and/or screening machine. The CCM can automatically sequentially start or stop devices of the machine and can be designed to do this with a single command signal from the operator. This single command capability allows use of simple remote control to operate the machine.

Additionally, the CCM is programmed so that when connected to other CCMs on a common network, the CCM can monitor the status of all other CCMs on that network. A typical network can be canbus cable. However if desired the system could be changed to use an Ethernet style of cable connected (hard wire connections) or wireless network. The CCM can then operate its crushing or screening machine based on the status of other crushing or screening machines. This network communication (control communication connection) allows crushing and screening machine sequencing and control for a complete system. The CCM can also make adjustments to optimize devices on its machine based on the status of other machines in the system. The single command capability allows use of simple remote control to operate a machine and system of machines.

An entire crushing and screening system can be automatically controlled with a single command from a single CCM machine. The starting/interlocking hierarchy of each CCM machine can be input by the operator during initial machine setup. The hierarchy of machines can also be determined by the sequence in which the machines are plugged together by the control cable network (plug and play). Each CCM panel has an upstream and downstream connection port. This allows central control capabilities without the need and expense of a dedicated central control. The same CCM controls can control individual machines and can be used with other CCM controlled machines as an integrated system of machines without programming alterations.

Safety is improved when compared to manually operated switch controls when mounted to individual machines. Operators of these machines must traverse from machine to machine to control them which can put the operator in areas of risk. Also, the time delay to traverse can invite a hurried response from the operator which further increases risk of injury, especially in cases when a machine problem arises.

Now referring to FIG. 18, which shows a CCM style system where the operation sequence “hierarchy” is defined by the operator or by the plug and play sequence of the network cable. The operator only needs to apply a single start command from the furthest upstream unit indicated at #1 and the CCM communicates to start furthest downstream unit first and progress sequentially through the remaining plants. The CCM automatically sounds warning horns for a predetermined period before allowing any device to start and continues the warning until all devices have started. If a problem is noticed, anywhere in the system, the operator only needs to traverse to nearest CCM control, in this case location #3, and touch the auto stop button to shut plant down automatically.

Set up sequence number 1 through 5 at set up. Entire system starts from unit 1, one touch. An operator located between location 2 and 3 would need to move to either location 2 or 3 and from there could stop all the units without any need to walk under a conveyor.

The CCM controls can also sequentially start all large horsepower devices (crusher motors) first before starting remaining lower horsepower devices. This allows time for large devices to ramp up gradually to minimize demand on generator power. This also allows quick start of conveyors so spillage at transfer points is contained or minimalized. This reduces downtime to clear spills and prevents damage due to material overloads.

The CCM controls also can monitor status on other CCMs and adjust the machine as desired to optimize flow through the machine and the system. The CCM of machine #1 can monitor the critical flow level at unit #5 and adjust its output to the desired flow at the critical or limiting device located on unit #5. Additional material sensors can be deployed to detect the presence of material or conditions which may damage equipment when set limits are exceeded. Sensors can be utilized to start and stop certain devices, such as dust suppression, so they only operate when material is present in that location.

Each panel capable to add sensors, one for optimizing, other for material sensing. Unit with variable speed feed is set to optimize on sensor of choice (Example 5-1). Sensor 1-2 is selected at set up of unit 1 to determine presence of material. Other sensors can be set to detect over flow or interference and initiate auto stop function. Sensors can be used to detect material presence to control auxiliary equipment on/off, for example, dust suppression.

In addition to automation, the CCM eliminates many potential fault points such as individual push buttons, mechanical and programmable relays, timers and switches. These reduced failure points provide a control system with improved reliability, improved ease of operation, and provides automatic control with any combination or quantity of machines as well as standalone operation.

The CCM with its standardized inputs and outputs allow for uniform design of machine electrical schematics and wiring methods. This improves ease of manufacture and also training of technicians as well as trouble shooting. Trouble shooting is further improved and quicker due to built-in error detection by the CCM, which can communicate the location and type of fault within the machine or system of machines.

The CCM is also expandable to communicate to a central control station if desired. The status of all CCM machines is broadcast so a central control station can monitor and display all machines in the system.

The terms “road building materials” are used throughout this description as an example of a common use of aggregate materials. It should be understood that the terms “road building materials” are intended to include aggregate materials, irrespective of the actual use to which such aggregate materials may be put. Similarly, the terms “rock crusher” are used as a common example of the use of a crusher; however, the terms “rock crusher” are intended to include any crusher, whether it is rock, concrete, or any other material that is being crushed.

It will be understood that certain features and sub-combinations are of utility and may be employed without reference to other features and sub-combinations. This is contemplated by and is within the scope of the claims.

Since many possible embodiments may be made of the invention without departing from the scope thereof, it is understood that all matter herein set forth or shown in the accompanying drawings is to be interpreted as illustrative and not in a limiting sense.

1. An aggregate processing system comprising:
a first aggregate processing plant having therein a first electrically powered device for performing at least one of crushing aggregate and screening aggregate;
a first common control module; disposed on and said first aggregate processing plant and configured to control said first electrically powered device;
a second aggregate processing plant having therein a second electrically powered device for performing at least one of crushing aggregate and screening aggregate;
a second common control module; disposed on and said second aggregate processing plant and configured to control said second electrically powered device; and
said first common control module and said second common control module are identically configured, so as to permit replacement of one by the other, without affecting operation of any one of said first aggregate processing plant and said second aggregate processing plant.

2. The aggregate processing system of claim 1 wherein said first electrically powered device is configured for crushing aggregate and said second electrically powered device is configured for screening aggregate and each of which are powered through device switchgear.

3. The aggregate processing system of claim 1 further comprising a single communication connection, coupled between, said first aggregate processing plant and said second aggregate processing plant, which is a sole source of communication between said first aggregate processing plant and said second aggregate processing plant.

4. The aggregate processing system of claim 3 wherein in said single communication connection is a first canbus cable.

5. The aggregate processing system of claim 4 wherein each of said first aggregate processing plant and said second aggregate processing plant are configured to receive a second canbus cable from a third aggregate processing plant.

6. The aggregate processing system of claim 5 wherein each of said first common control module and said second common control module are configured with only two identical plug engaging structures for receiving a canbus cable.

7. The aggregate processing system of claim 1 wherein each of said first aggregate processing plant and said second aggregate processing plant are free from any external source of control signals other than from each other.

8. The aggregate processing system of claim 4 wherein said first aggregate processing plant and said second aggregate processing plant are configured to operate independently if said first canbus cable is removed.

9. The aggregate processing system of claim 1 wherein said first common control module and said second common control module are each configured to automatically stop the other with a single command.

10. The aggregate processing system of claim 1 further comprising a remote control and said first aggregate processing plant and said second aggregate processing plant being free of any master-slave relationship.

11. A method of processing aggregate material with an aggregate processing system comprising the step of:
providing a first aggregate processing plant, with a first common control module;
providing a second aggregate processing plant, with a second common control module;
connecting said first common control module to said second common control module with a first control communication connection;
wherein each of said first common control module and said second common control module are free of any connection to a central control hub which is coupled to and transmits control signals to both said first common control module and said second common control module; and
processing aggregate material by providing an input of matter into said first aggregate processing plant which outputs to said second aggregate processing plant.

12. The method of claim 11 wherein each said first common control module and said second common control module are identically configured, so as to permit replacement of one by the other, without affecting operation of any one of said first aggregate processing plant and said second aggregate processing plant.

13. The method of claim 12 wherein said first control communication connection comprises coupling a hard wire connection.

14. The method of claim 13 further comprising the steps of:
performing an aggregate processing system self-configuration procedure by initiating a predetermined set up program by a single activation of a single control on said first common control module, which thereby enables stopping of said second aggregate processing plant from said first aggregate processing plant and stopping of said first aggregate processing plant from said second aggregate processing plant.

15. The method of claim 14 further comprising the steps of:
providing a third aggregate processing plant and coupling said third aggregate processing plant, with a third common control module, to either one of said first aggregate processing plant and said second aggregate processing plant; and
performing an aggregate processing system self-configuration procedure by initiating a predetermined set up program by a single activation of a single control one of said first common control module, said second common control module and said third common control module, which thereby enables control of said first aggregate processing plant, said second aggregate processing plant, and said third aggregate processing plant from a most upstream one of said first aggregate processing plant, said second aggregate processing plant and said third aggregate processing plant which thereby enables control of each of said first aggregate processing plant, said second aggregate processing plant; and said third aggregate processing plant from any of said first aggregate processing plant, said second aggregate processing plant; and said third aggregate processing plant;
said first aggregate processing plant, said second aggregate processing plant and said third aggregate processing plant being free of any master-slave relationships; and
processing aggregate material through each of said first aggregate processing plant, said second aggregate processing plant; and said third aggregate processing plant.

16. A method of reconfiguring an aggregate processing system comprising the steps of:
providing a previously configured and previously operated aggregate processing system which has a first aggregate processing plant, with a first common control module and a second aggregate processing plant, with a second common control module;
adding a third aggregate processing plant, with a third common control module to the aggregate processing system; and
providing a single control communication connection between said third aggregate processing plant and said previously configured and previously operated aggregate processing system, by directly coupling said third aggregate processing plant to, any one of and only one of, said first aggregate processing plant and said second aggregate processing plant.

17. The method of claim 16 wherein said first aggregate processing plant, said second aggregate processing plant and said third aggregate processing plant are coupled, by only two functionally identical can cables, which carry all inter plant system control signals.

18. The method of claim 16 further comprising the steps of:
performing an aggregate processing system self-configuration procedure by initiating a predetermined set up program by a single activation of a single control one of said first common control module, said second common control module and said third common control module, which thereby enables control of said first aggregate processing plant, said second aggregate processing plant, and said third aggregate processing plant from a most upstream one of said first aggregate processing plant, said second aggregate processing plant and said third aggregate processing plant which thereby enables shutdown control of each of said first aggregate processing plant, said second aggregate processing plant; and said third aggregate processing plant from any of said first aggregate processing plant, said second aggregate processing plant; and said third aggregate processing plant.

19. The method of claim 18 where said first aggregate processing plant performs a crushing step and said second aggregate processing plant performs a screening step and there is no master slave relationship between said first aggregate processing plant and said second aggregate processing plant.

20. The method of claim 19 wherein said first common control module, said second common control module, and said third common control module are functionally identical and interchangeable.
